(19) United States
(12) Patent Application Publication
(10) Pub. No.: US 2013/0026164 A1
(43) Pub. Date: Jan. 31, 2013

(54) APPARATUS AND METHOD FOR SEALING THERMOPLASTIC WELDS

(71) Applicants: F. Joseph Lingel, Lynnfield, MA (US); Michael Ashley, Ipswich, MA (US); William Bruns, North Andover, MA (US)

(72) Inventors: F. Joseph Lingel, Lynnfield, MA (US); Michael Ashley, Ipswich, MA (US); William Bruns, North Andover, MA (US)

(73) Assignee: UNITED PLASTIC FABRICATING, INC., Andover, MA (US)

(21) Appl. No.: 13/559,920

(22) Filed: Jul. 27, 2012

Related U.S. Application Data
(60) Provisional application No. 61/512,019, filed on Jul. 27, 2011.

(51) Int. Cl. F16J 15/02; B65D 6/32

(52) U.S. Cl. 220/4.01; 277/650

(57) ABSTRACT

A system is provided for the sealing of a thermoplastic weld, the system comprising: a first and second thermoplastic components; a channel disposed in opposing faces of the first and second thermoplastic components; a sealing member disposed within the channel sealing a joint between the opposing faces; and at least one thermoplastic weld joining the opposing faces proximate to the sealing member.

### RELATED APPLICATIONS

This application claims the benefit of U.S. Provisional Application No. 61/512019, filed Jul. 27, 2011. This application is herein incorporated by reference in its entirety for all purposes.

### FIELD OF THE INVENTION

The invention relates to thermoplastic welds, and more particularly, to a storage tank sealed with an interstitial seal between surfaces of thermoplastic members joined by welds.

### BACKGROUND OF THE INVENTION

Known tank fabrication relies on various plastic welding techniques including the provision of heated weld rods on interior and exterior surfaces of a welded joint, effectively sealing the joint, but leaving a void between the two seals. If the interior weld is compromised fluid within the tank may travel in the void until it finds an outlet in the exterior weld, resulting in a leak, the source of which may be at a significant distance from the outlet. This makes finding the source difficult, complicating repair.

What is needed, therefore, are techniques for preventing fluid from traveling through the weld void.

### SUMMARY OF THE INVENTION

One embodiment of the present invention provides a system for the sealing of a thermoplastic weld, the system comprising: a first and second thermoplastic components; a channel disposed in opposing faces of the first and second thermoplastic components; a sealing member disposed within the channel sealing a joint between the opposing faces; and at least one thermoplastic weld joining the opposing faces proximate to the sealing member.

Another embodiment of the present invention provides such a system wherein the sealing member comprises a polymer selected from the group of polymers consisting of polyolefins, polyamides, and polychloropenes.

A further embodiment of the present invention provides such a system wherein the channel has a grooved cross section, the grooved cross section being selected from the group of grooved cross sections consisting of rectangular cross section, semicircular cross section, triganal cross section, and asymmetric cross sections.

Yet another embodiment of the present invention provides such a system wherein the sealing member is a tape.

A yet further embodiment of the present invention provides such a system wherein at least one thermoplastic weld comprises first and second welds disposed on interior and exterior surfaces of the opposing faces.

Still another embodiment of the present invention provides such a system wherein the first and second thermoplastic components are walls of a fluid storage tank.

One embodiment of the present invention provides a tank, the tank comprising: a plurality of tank members; at least one joint disposed between first and second tank members; the joint comprising a first weld, a first sealant channel, and a sealant, the first sealant channel being disposed within the joint, the sealant being disposed within the first sealant channel and the weld holding the joint secure; the sealant configured to prevent leakage of a content of the tank through the joint.

Another embodiment of the present invention provides such a tank wherein the tank members are panels.

A further embodiment of the present invention provides such a tank wherein the tank members are plastic.

Yet another embodiment of the present invention provides such a tank further comprising a second sealant channel disposed opposite to the first sealant channel.

A yet further embodiment of the present invention provides such a tank wherein the sealant is disposed between the first and the second sealant channels.

Even another embodiment of the present invention provides such a tank wherein the sealant channel comprises a chamfer disposed on a corner of a first tank member.

An even further embodiment of the present invention provides such a tank wherein the chamfer is disposed in a rabbet in a second tank member defining the joint.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is an elevation view illustrating a weld seal configured in accordance with one embodiment of the present invention.

FIG. 2 is an elevation view illustrating a weld seal configured in accordance with an alternative embodiment of the present invention.

FIG. 3 is an elevation view illustrating a weld seal configured according to an alternative embodiment of the present invention.

FIG. 4A is an expanded elevation view illustrating the assembly method of a weld seal configured according to an alternative embodiment of the present invention.

FIG. 4B is an elevation view illustrating the assembly method of a weld seal configured according to the embodiment of the present invention illustrated in FIG. 4A.

### DETAILED DESCRIPTION

One embodiment of the present invention provides a “plastic” sheet 12 having a sealing slot cut 14 in the edge of the sheet adjacent to where a weld 16 will occur. A sealant 18 is placed inside the sealing slot 14 prior to welding the sheet thereby allowing the sealant 18 to act as a barrier to prevent the loss of the liquid being stored in the liquid storage vessel.

The sealant material, of one embodiment, prevents any liquid from passing through a void on the first (interior or sealing) weld thus avoiding leaks from occurring in the event of a void or breakage of the second (exterior or structural weld) weld. In many cases where no sealant is provided, when a first weld fails, liquids will travel along the space behind the weld until it finds an outlet unless prevented by a barrier. In known systems where a single weld is typically relied upon for sealing containers, in the absence of barriers behind the weld there would be no barrier to leakage. In some systems a second or structural weld, may be provided, and while not intended to provide sealing, if there is no barrier, this second weld would be sole means of preventing leaks. The addition of the sealant 18 material prevents the liquid from reaching that second weld, if there is a second weld. According to one embodiment of the present invention, the provision of a sealant barrier 18 between the first 16 and second welds 15 allows the welds to be used primarily in a manner to structurally join the sheets, but only secondarily as a liquid sealing element.

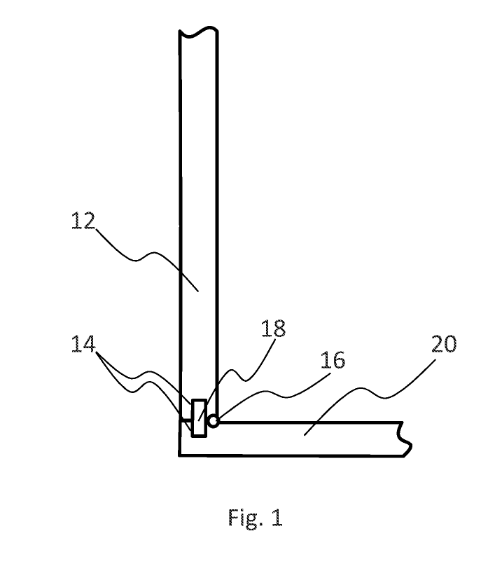

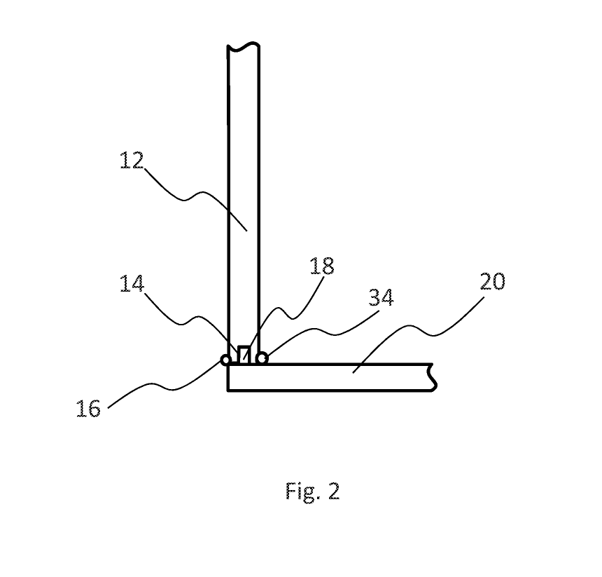

The sealant 18 of one embodiment of the present invention will be contained in a sealing slot or channel 14 between the two sheets of “plastic” 12, 20 being joined and act as a barrier to prevent liquid from passing through a weldment void. In one embodiment, the sealing slot or channel 14 may be disposed in one of the two sheets 12, while in other embodiments, slots or channels 14 may be provided in both sheets and the sealant disposed partially in both slots, as illustrated in FIG. 1. In embodiments where a single slot 14 is used, as illustrated in FIG. 2, the sealant may be adhesive and adhere to the surface of the non-slotted sheet. In such embodiments, when a failure occurs in an interior weld that allows the liquid to seep into the voided area where the two sheets are joined by contact (past the weld), the sealant will act as a barrier and not permit the liquid to pass and come in contact with the exterior weld. In cases where only one weld is applied, a sealant barrier configured in accord with the embodiments of the present invention, will prevent loss of the stored liquid.

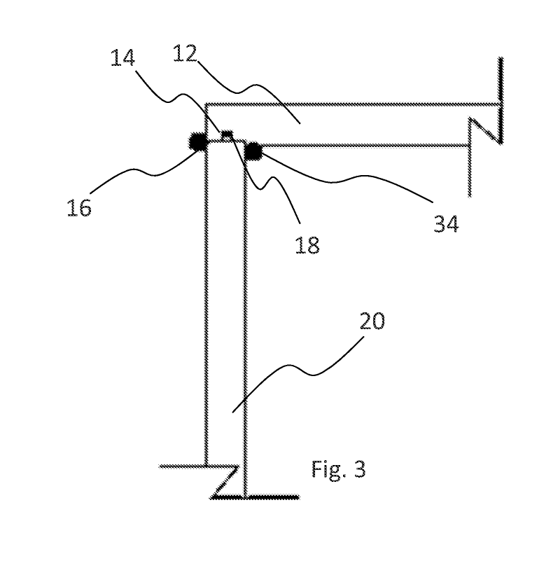

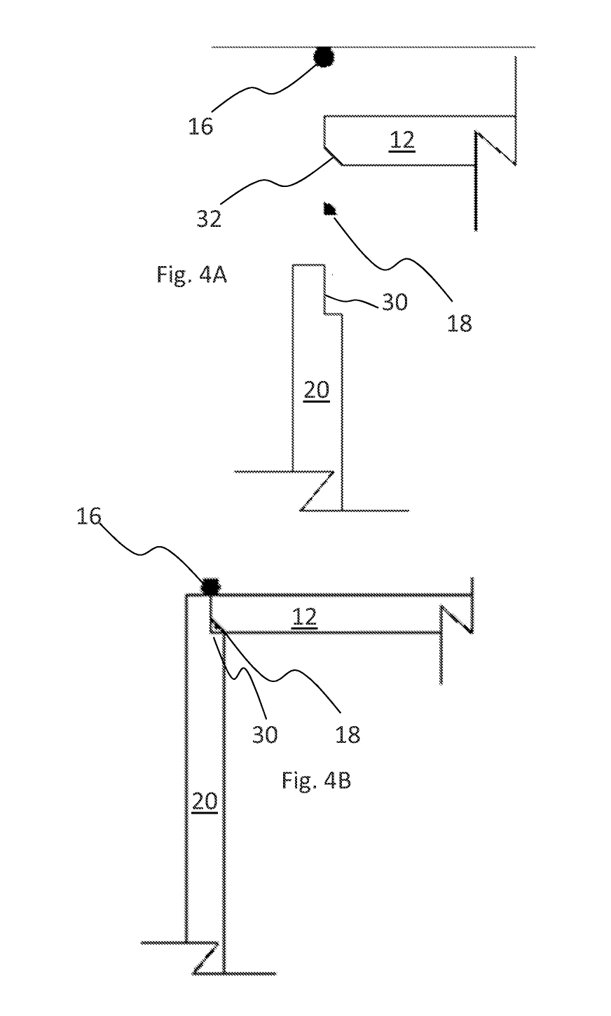

As illustrated in FIG. 3, the channel 14 may be disposed in a side of one panel 12 while the end of a second panel 20 is butted against the channeled section and welded. An alternative corner connection is illustrated in FIGS. 4A and 4B where an L shaped shoulder or rabbet 30 is formed in the end of one panel 12 with a chamfer 32 on a corresponding edge. Connection of the rabbet 30 with the chamfer 32 creates a space in which the sealant 18 is disposed.

One embodiment of the present invention can be used on any plastic material that is welded and used to contain a liquid or solid that may leak or seep if a weld seam were to fail. One skilled in the art will appreciated that the sealant material itself may be a compressible or conformable material, or an adhesive material having suitable sealing characteristics and resistant to the liquid or solid contained in the storage tank.

In one embodiment of the present invention, the sealing material is pliable and selected to adhere to the thermoplastic sheets. The sealing material is selected so as to resist migration from the sealant channel or slot, as such migration would compromise the structural integrity of the plastic welds.

One embodiment of the present invention comprises a process providing a precise width and depth for the channel or slot for the proper positioning of the sealant. As such, the sealant and spline may be adjusted based on the dimensions of the joint, the liquid or solid contained by the tank, and other characteristics understood by those skilled in the art. In addition, the sealant material may be provided with selected properties that allow it to reside in the track for extended time without degrading and be able to resist liquids should they enter the track. Sealants which may be employed include, but are not limited to polyolefins, polyamides, polychloropenes, butyl tapes, vinyl tapes, polyamide tapes, polychloropene tapes, nitrate polymer tapes. Examples of such sealants include those sold under the respective trade names CRL Sealant tape; ST 132×14, ST 18×34 sealant tape, ST18×1 sealant tape and ST132×12 sealant tape; CRL 213212 (1/32″×½″) form mounting tape; deVan 578.12 Orange Butyl tape (⅛″×¼″); deVan 581.12 Gray Butyl tape ( 3/32″ diameter); Phifer Screening spline (⅛″ diameter; 3M Weatherban Sealant tape -Butyl; 3M adhesives with either a neoprene or nitrate based gasket; Tremco Butyl Glazing tapes; Tremco Butyl Sealant; Denso Butyl rubber Adhesive tape

In one embodiment of the present invention, the sealant material is installed in the channel or slot in such a way as both the sealant and the channel or slot are substantially free of dust, debris, moisture, grease or other contaminants. Installation may be made at temperatures suitable for the sealant selected, in most instances ambient temperature is desirable.

In one embodiment of the present invention, the sealant material is provided in a continuous seal at all joints thus configured. Where joints intersect, the sealant material may be adhered to itself, forming a continuous barrier.

In one embodiment of the present invention, the sealing material is used in the process of joining together body components such as compartments, fenders, walls, and doors, to act as a barrier to prevent the contamination of the contents of the compartments from outside dirt and moisture to preserve the contents from corrosive effects. Further, the sealant material ensures that over the life of the vehicle body components, any weld separation that might occur due to extended vehicle use will not cause contamination of the contents of the compartment and will provide secondary seal capability to all body components.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

We claim:

1. A system for the sealing of a thermoplastic weld, the system comprising:
a first and second thermoplastic components;
a channel disposed in opposing faces of said first and second thermoplastic components;
a sealing member disposed within said channel sealing a joint between said opposing faces;
at least one thermoplastic weld joining said opposing faces proximate to said sealing member.

2. The system according to claim 1 wherein said sealing member comprises a polymer selected from the group of polymers consisting of polyolefins, polyamides, and polychloropenes.

3. The system according to claim 2 wherein said channel has a grooved cross section, said grooved cross section being selected from the group of grooved cross sections consisting of rectangular cross section, semicircular cross section, triganal cross section, and asymmetric cross sections.

4. The system according to claim 1 wherein said sealing member is a tape.

5. The system of claim 1 wherein said at least one thermoplastic weld comprises first and second welds disposed on interior an exterior surfaces of said opposing faces.

6. The system of claim 1 wherein said first and second thermoplastic components are walls of a fluid storage tank.

7. The system according to claim 1 wherein said first and second thermoplastic components are walls of a vehicle body

8. The system according to claim 1 wherein said sealing member is caulking.

9. A tank, said tank comprising:
a plurality of tank members;
at least one joint disposed between first and second tank members;
said joint comprising a first weld, a first sealant channel, and a sealant, said first sealant channel being disposed within said joint, said sealant being disposed within said first sealant channel and said weld holding said joint secure;
said sealant configured to prevent leakage of a content of said tank through said joint.

10. The tank of claim 9, wherein said tank members are panels.

11. The tank of claim 9 wherein said tank members are plastic.

12. The tank of claim 9 further comprising a second sealant channel disposed opposite to said first sealant channel.

13. The tank of claim 12 wherein said sealant is disposed between said first and said second sealant channels.

14. The tank of claim 9 wherein said sealant channel comprises a chamfer disposed on a corner of a first tank member.

15. The tank of claim 14 wherein said chamfer is disposed in a rabbet in a second tank member defining said joint.
